(19) United States
(12) Patent Application Publication
(10) Pub. No.: US 2010/0127080 A1
(43) Pub. Date: May 27, 2010

(54) SCANNING DEVICE HAVING ADJUSTABLE LIGHT PATH

(76) Inventor: CHIN-TIN HSIAO, Taoyuan Hsien (TW)

Correspondence Address: LEONG C LEI, PMB # 1008, 1867 YGNACIO VALLEY ROAD, WALNUT CREEK, CA, 94598, US

(21) Appl. No.: 12/324,840

(22) Filed: Nov. 27, 2008

(51) Int. Cl. G06K 7/10

(52) U.S. Cl. 235/462.01

(57) ABSTRACT

The scanning device contains a seat, an image sensor at a back side of the seat, and a light generation assembly inside the seat. The light generation assembly contains at least a light generation element, at least a light bar, a lens, and a stop separated from the lens. The lens is positioned in front of the image sensor and the stop is positioned in front of the lens. The light bar at a side of the stop is positioned in front of the light generation element which in turn is at a side of the lens. The light generation element is moveably positioned so that it could be adjusted to overlap its light projected range with the range received by the lens. The image sensor therefore captures the strongest optical signal and allows for a faster scanning speed.

### TECHNICAL FIELD OF THE INVENTION

The present invention generally relates to barcode or similar readers, and more particularly to a scanning device for barcode or similar readers whose light projected path could be adjusted.

### DESCRIPTION OF THE PRIOR ART

Barcode readers using laser light source have the advantage of faster scanning speed but with shorter lifespan and potential hazard to the operator's eyes. Barcode readers using light emitting diodes (LEDs) as light source, as disclosed by U.S. Pat. Nos. 4,743,773, 5,449,892, 6,119,939, 6,729,546, etc., do not present a threat to the operator but suffers slower scanning speed. Please also refer to Taiwan Patent No. M314,889 and FIG. 9 for another conventional barcode scanner. As illustrated, the barcode scanner contains a body 80 and a lighting assembly 90. The body 80 has a front opening 81 for the passage of light. The lighting assembly 90 contains at least a light generation element 91, at least a light bar 92, a lens 93, a light sensor/receiver 94 and a reflective mirror 95. The light bars 92 are positioned about more than 10 mm in front of the light generation elements 91 and light sensor/receiver 94 is positioned behind the lens 93.

The foregoing prior arts suffer the following shortcomings. First of all, the light generation elements 91 and the light bars 92 cannot be adjusted once installed. However, if there is some misalignment, the projected light is deviated and therefore cannot be appropriately reflected back to the light sensor/receiver 94. As such, the scanning speed of the barcode reader is significantly impaired.

Secondly, the lens 93 of the conventional lighting assembly 90 usually has a built-in stop so that the lens 93 is quite bulky. The body 80 therefore has to be bigger so as to accommodate the lens 93 and the light bars 92 at the lens 93's sides. Compared to the light bars 92 and the lens 93, the much smaller light generation elements 91 are on the other hand positioned separately at a distance. The overall result is significantly inefficient utilization of body 80's space.

### SUMMARY OF THE INVENTION

Therefore, s novel scanning device for barcode or similar readers using LEDs as light source is provided herein to obviate the foregoing shortcomings of the prior arts.

A scanning device according to an embodiment of the present invention contains a seat, an image sensor at a back side of the seat, and a light generation assembly inside the seat. The light generation assembly contains at least a light generation element, at least a light bar, a lens, and a stop separated from the lens. The lens is positioned in front of the image sensor and the stop is positioned in front of the lens. The light bar at a side of the stop is positioned in front of the light generation element which in turn is at a side of the lens, so as to achieve more efficient space utilization.

The light generation element is moveably positioned so that it could be adjusted to overlap its light projected range with the range received by the lens. The image sensor therefore captures the strongest optical signal and allows for a faster scanning speed.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a scanning device according an embodiment of the present invention.

FIG. 2 is a perspective exploded diagram showing the various components of the scanning device of FIG. 1.

FIG. 3 is a top view diagram showing the scanning device of FIG. 1.

FIG. 4 is a sectional diagram showing the vicinity of a light generation element inside the scanning device of FIG. 1.

FIGS. 5A and 5B are schematic diagrams showing the light projected path from a light generation element of the scanning device of FIG. 1.

FIG. 6 is a schematic diagram showing the relationship between the range projected by the light generation elements and the range received by the lens of the scanning device of FIG. 1.

FIG. 7 is a perspective diagram showing the scanning device of FIG. 1 joined to a circuit board of a barcode reader.

FIG. 8 is a sectional diagram showing the adjustment of a light generation element of the scanning device of FIG. 1.

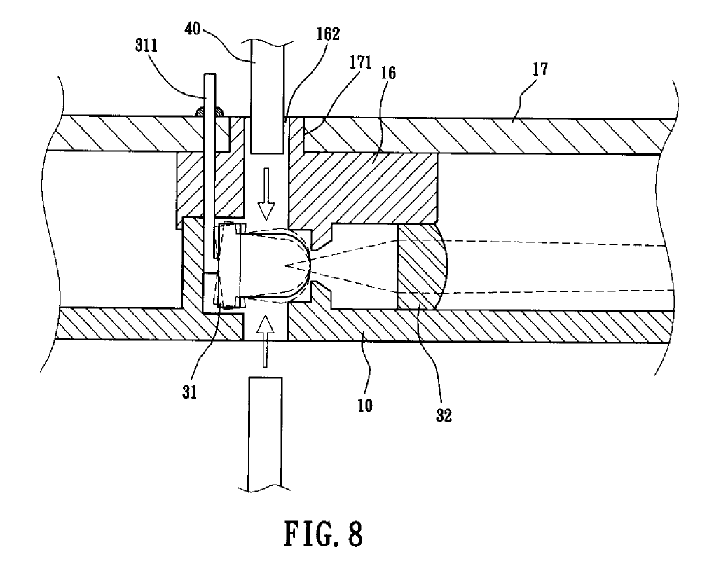

FIG. 9 is schematic diagram showing the layout of components of a conventional barcode reader.

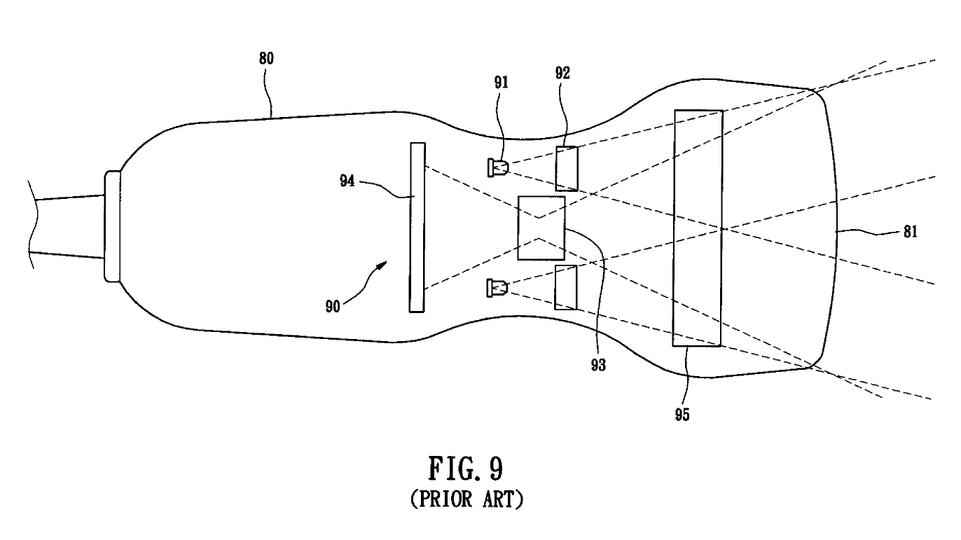

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

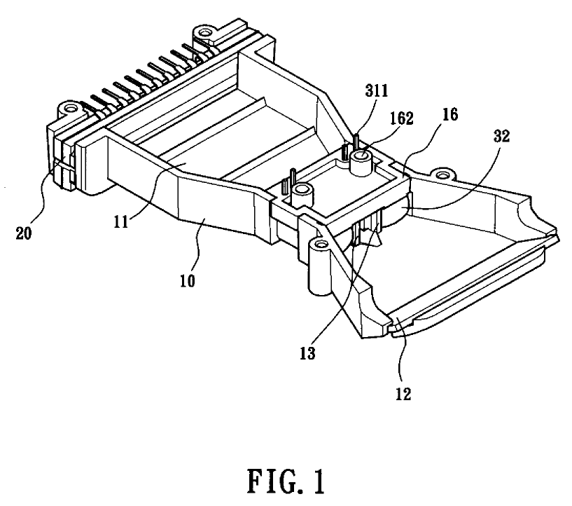

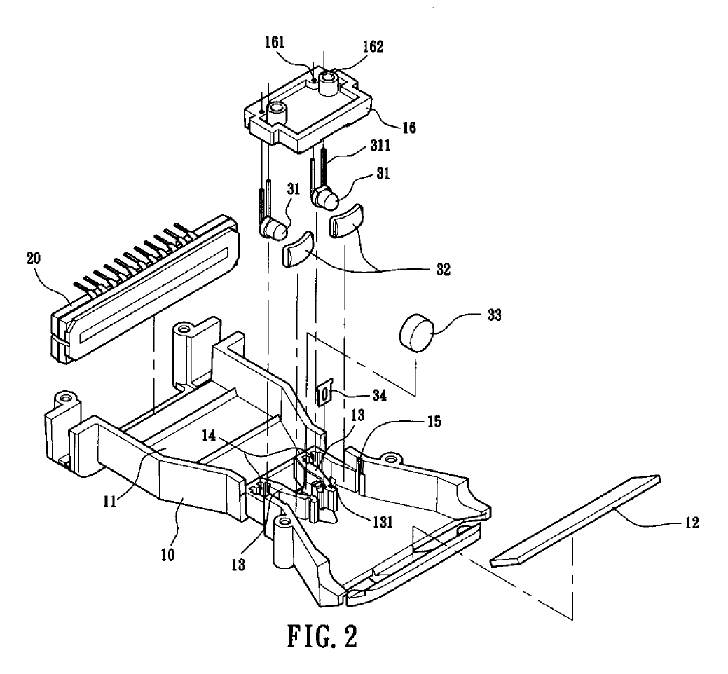

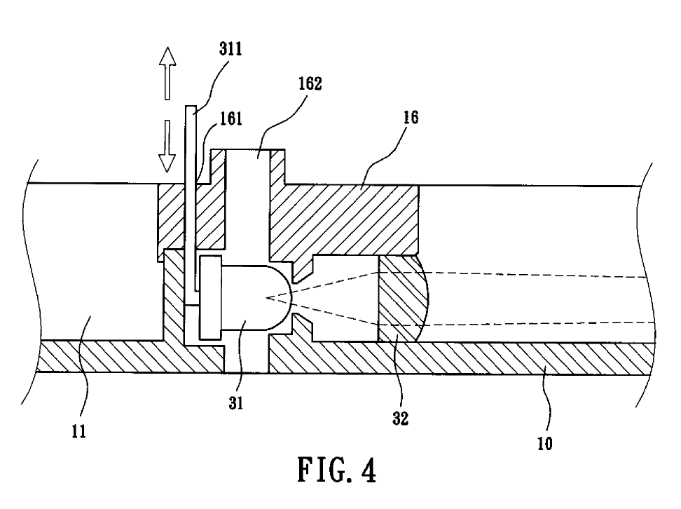

As shown in FIGS. 1 to 4, a scanning device according to an embodiment of the present invention contains a seat 10, an image sensor 20, and a light generation assembly 30.

The seat 10 is walled along its two lateral sides and opened to a front side, a back side, and a top side to form an internal storage space 11. A transparent plate 12 allowing passage of light is provided to the front side of the seat 10. The image sensor 20 is provided to the back side of the seat 10 to receive the reflected light when the scanning device is in operation.

Two partitions 13 are provided in a middle section of the space 11, forming two slots 14 in parallel with a gap therebetween and each with gradually enlarged opening towards the front side. At the openings of the two slots 14, there are vertical grooves 131 and 15, respectively. Also a cover 16 is provided on top of the partitions 13 and the slots 14. The cover 16 has a number of through holes 161 and two adjustment holes 162. The light generation assembly 20 contains two light generation elements (such as light emitting diodes) 31, two light bars 32, a lens 33, and a stop (also called diaphragm) 34. Please note that the stop 34 is separated from the lens 33. The two light generation elements 31 are positioned in the slots 14, respectively. Each light generation element 31 has two flexible terminals 311 and these terminals 311 are extended vertically upward through the through holes 161 of the cover 16. By pulling or pushing the terminals 311, the light generation elements 31 could be adjusted inside their respective slots 14. The lens 33 is held between the partitions 13 in front of the image sensor 20 and the stop 34 is also held between the partitions 13 in front of the lens 33. The light bars 32 could be cylindrical lenses and they are held in front of the light generation elements 31 by the grooves 15, 131 of the slots 14, respectively. Please note that the above arrangement of the elements of the light generation assembly 30 effectively requires a less amount of space than that required by the prior arts and therefore could help reducing the production cost and the size of the scanning device.

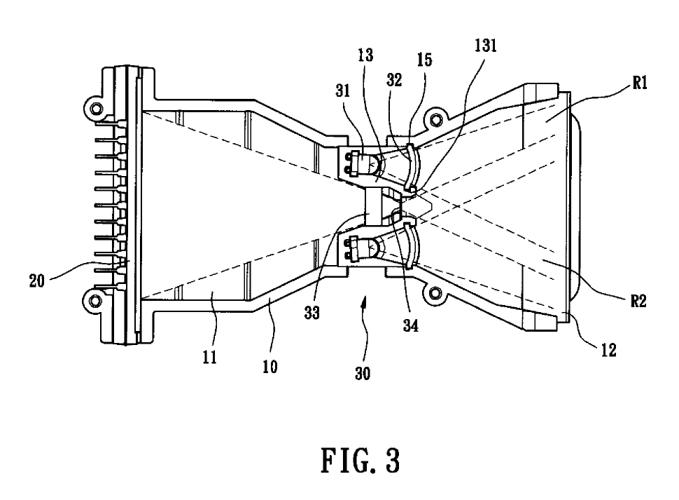

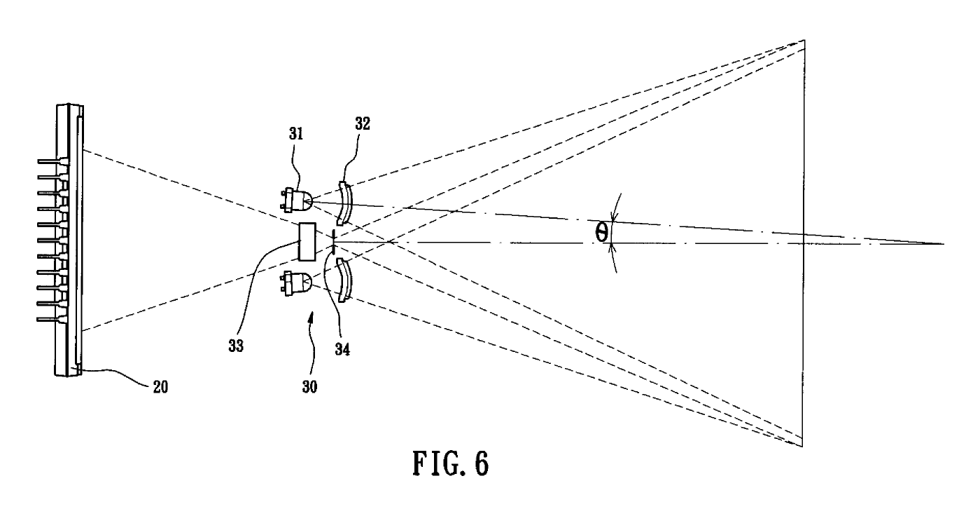

Further more, as shown in FIGS. 3 and 6, the above arrangement of the elements of the light generation assembly 30 achieves the smallest included angle θ between an axis of the lens 33 and an axis of the light generation element 31. As such, a projecting range R1 of the light generation element 31 would nearly overlap a receiving range R2 of the lens 33. The image sensor 20 would therefore receive the strongest optical signal, thereby allowing a faster scanning speed.

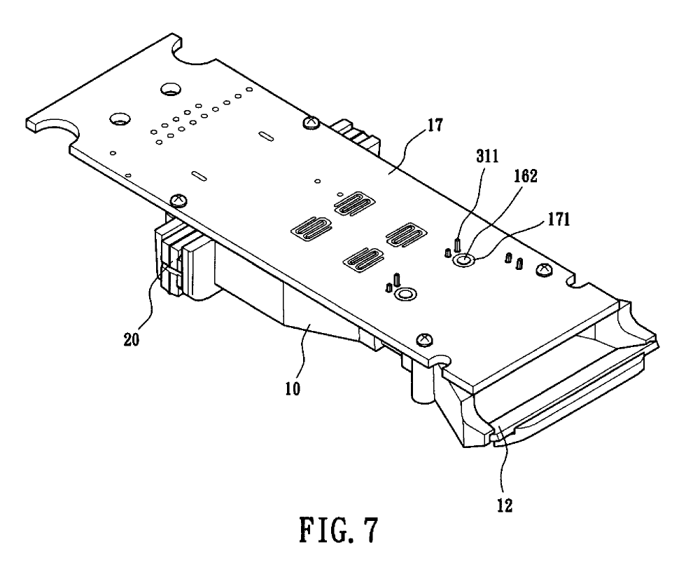

As shown in FIG. 7, the scanning device described above is attached to a side of a circuit board 17 containing various electrical elements of, for example, a barcode reader. The circuit board 17 has a number of holes 171 receiving the adjustment holes 162 of the cover 16. The terminals 311 of the light generation elements 31, after extending through the through holes 161 of the cover 16, are soldered to the circuit board 17.

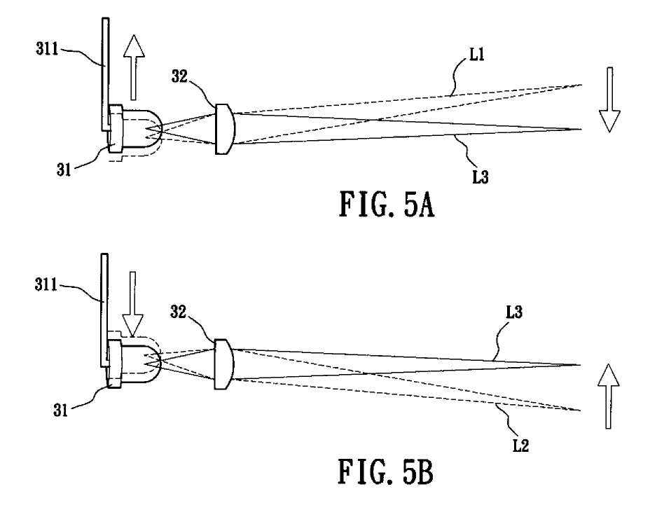

The light generation elements 31 are first aligned with the light bars 32 by manipulating their terminals 311 before being soldered to the circuit board 17. However, as shown in FIG. 5A, when the light generation element 31 is a bit below its ideal position relative to the light bar 32, its projected light path L1 would be above the ideal path L3. In this case, the light generation element 31 should be adjusted upward. Similarly, as shown in FIG. 5B, when the light generation element 31 is a bit above its ideal position, its projected light path L2 would be projected too low and it should be adjusted downward to correct the misalignment.

As shown in HG 8, according to the present invention, the slots 14 where the light generation elements 31 are positioned are configured such that some room is reserved for the adjustment of the light generation elements 31. Together with the flexibility of the terminals 311, each light generation element 31's alignment could be adjusted by using a bar 40 to push against the light generation element through the adjustment hole 162 above the light generation element 31, or a correspond hole (not numbered) of the seat 10 beneath the light generation element 31.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-7. (canceled)

8. A scanning device, comprising:
a seat;
an image sensor at a back side of said seat;
a light generation assembly inside said seat, said light generation assembly having at least a light generation element projecting towards a front side of said seat, at least a light bar, a lens, and a stop separated from said lens, said light generation element being movably positioned inside said seat, said lens being in front of said image sensor, said stop being in front of said lens, said light bar at a side of said stop being positioned in front of said light generation element which in turn is at a side of said lens;
wherein said scanning device comprises a cover on top of said light generation assembly, said cover has at least a through hole allowing a terminal of said light generation element to extend through, said cover has at least an adjustment hole above said light generation element for adjusting said light generation element's light projection path, said scanning device is attached to a side of a circuit board, and said circuit board has at least a through hole corresponding to said adjustment hole of said cover.

9. The scanning device according to claim 8, wherein said light generation element has flexible terminals.

10. The scanning device according to claim 8, wherein said seat has at least a slot for moveably positioning said light generation element.

11. The scanning device according to claim 10, wherein said light bar is held by grooves provided at a front opening of said slot.
